(19) United States
(12) Patent Application Publication
(10) Pub. No.: US 2026/0210423 A1
(43) Pub. Date: Jul. 23, 2026

(54) ELASTOMER ADHESIVES FOR BELT PRODUCTS

(71) Applicant: GATES CORPORATION, Denver, CO (US)

(72) Inventors: Kelechi C. ANYAOGU, Rochester Hills, MI (US); Cynthia DECKER, Columbia, MO (US); Bobbie E. SOUTH, Columbia, MO (US); Joseph R. DUKE, JR., Elizabethtown, KY (US); William W.L. WU, Elizabethtown, KY (US)

(73) Assignee: GATES CORPORATION, Denver, CO (US)

(21) Appl. No.: 19/144,371

(22) PCT Filed: Dec. 13, 2023
(86) PCT No.: PCT/US2023/083919

§ 371 Date: Jun. 27, 2025

Related U.S. Application Data
(60) Provisional application No. 63/478,023, filed on Dec. 30, 2022.

(51) Int. Cl. F16G 1/10; B29D 29/08; C09J 11/06; C09J 109/00; F16G 1/28

(52) U.S. Cl. CPC F16G 1/10; B29D 29/08; C09J 11/06; C09J 109/00; F16G 1/28

(57) ABSTRACT

Polybutadiene-based elastomeric adhesive compositions for treating load carrying cords and other textiles for flexible belts, including synchronous belts. The elastomeric adhesive compositions have at least one polybutadiene-based polymer, which when cross-linked, forms covalent bonds with the surrounding belt polymer. The elastomeric adhesive compositions can include a cross-linker and/or a solvent (either aqueous or organic).

### CROSS-REFERENCE TO RELATED APPLICATIONS

This application claims priority to International Application No. PCT/US2023/083919 filed Dec. 13, 2023, which claims priority to U.S. Provisional Patent Application Ser. No. 63/478,023 filed Dec. 30, 2022, both of which are incorporated herein in their entirety by reference.

### TECHNICAL FIELD

The present application relates to elastomer blends for treatment of reinforcing fibers, cords, or textiles for use in flexible belts.

### BACKGROUND

Flexible belts, such as power transmission belts and other belts used for automotive or other mobility uses, are normally constructed with a layer of fibers, textile or cords as reinforcement extending the length of the belt, to provide improved stretch resistance and improved tracking of the belt. Often, these fibers, textile or cords are treated with an adhesive to improve the adhesion between the reinforcement and the rubber or polymeric belt body.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure is directed to elastomeric adhesive compositions for treating load carrying cords and other textiles for flexible belts, including synchronous belts having, e.g., moderate to high temperature resistance, good oil resistance, flexibility down to −40° C. and high structural integrity. The elastomeric adhesive compositions have at least one polybutadiene-based polymer, which when cross-linked, forms a covalent bond with polymers forming the belt body. The elastomeric adhesive compositions can include latex, urethane acrylate elastomer, co-agents, a cross-linker and/or a solvent (either aqueous or organic).

The elastomer adhesive can be used with rubber or polyurethane belts.

In one particular implementation, described herein is a belt comprising a body having a plurality of load carrying cords having a polybutadiene-based adhesive composition encased therein.

In another particular implementation, described herein is a method of making a flexible belt, the method including forming a polybutadiene-based adhesive composition, coating the adhesive composition onto a plurality of load carrying cords, twisting the load carrying cords, and incorporating the twisted and adhesive coated cords into a polymeric belt.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a perspective view of an example belt made with an adhesive composition of the present disclosure.

FIG. 2 is a flow chart of an example method of applying an adhesive composition of the present disclosure.

### DETAILED DESCRIPTION

As indicated, the present disclosure is directed to an elastomer adhesive composition for the treatment of cords, the adhesive composition formed from at least one polybutadiene elastomer, such as a maleated polybutadiene.

The elastomer adhesive composition described herein is a new class of elastomer adhesive treatments for use in treating textiles (e.g., cords, fibers, scrims) for belt applications. The adhesive is applicable to multiple different cord materials including carbon, aramid, and polyester. The adhesive achieves sufficient penetration into the cords, whether pre-twisted or not pre-twisted. The cord may include a size coating (e.g., epoxy, urethane) prior to application of the adhesive. The adhesive provides physical and chemical protection to the cord and facilitates bonding to the belt body compound (e.g., rubber, polyurethane) thereby enabling better load transfer from the belt compound to the tensile cords.

Currently, polyurethane-based adhesives applied to pre-twisted carbon fiber are used in cast polyurethane belts. Such adhesives are primarily polyurethane and/or polyurea pre-polymers that can be cured in ambient conditions or by a curative; a post cure time is typically needed to obtain full strength in the cast polyurethane belts. Some adhesives utilize moisture curing.

The present elastomer adhesive described herein is formulated for compatibility with the cord or fibers (e.g., carbon) as well as with the belt composition, including rubber, polyurethane (PU) including milled polyurethane (MPU) and thermoplastic polyurethane (TPU), and ethylene elastomers (EE). Bonding (e.g., including cross-linking) of the adhesive with the belt composition may be via hydrogen bonding, electrostatic/ionic bonding, dipole to dipole interactions, Van der Waals interactions, and/or by covalent bonding. The curing process may be initiated or facilitated by peroxide or sulfur radicals, or photo-initiated radicals (from, e.g., UV, visible, or IR photoinitiators).

In the following description, reference is made to the accompanying drawing that forms a part hereof and in which is shown by way of illustration at least one specific implementation. The following description provides additional specific implementations. These implementations are disclosed in sufficient detail to enable those skilled in the art to practice the invention. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

The polybutadiene-based elastomer adhesive composition, for treating of the cords prior to incorporation into a flexible belt, is formed from at least one polybutadiene monomer or polymer that is cross-linked to eventually form a covalent bond with surrounding polymers, such as those forming the body of a belt. The polybutadiene backbone imparts moisture resistance to the cured composition. Polybutadienes modified with maleic anhydride, also referred to as maleated polybutadienes, have a relatively high amount of 1, 2-vinyl groups, which provide high levels of cross-linking. The polybutadiene may be modified with other functional groups, such as, silanes, hydroxyl, and epoxy groups.

Examples of usable polybutadienes include those available under the trade names Lithene™ Ultra AL, Lithene™ Ultra AH, Lithene™ Ultra PH, Lithene™ Ultra N4-5000, Ricon® 131, Ricon® 153, Ricon® 603, and Polyvest® EP ST-E 60. Examples of usable maleated polybutadienes include those available under the trade names Lithene™ Ultra AL-15MA, Lithene™ Ultra N4-5000-10MA, Ricobond® 1756, and Ricobond® 130MA20. Examples of usable hydroxy terminated polybutadienes include those available under trade names Krasol® LBH 200, Krasol® LBH 3000, Poly bd® R45 HTLO, Poly bd® 605E, and Polyvest® HT. Other polybutadienes, of course, are also usable.

The elastomer adhesive composition is also formed with a solvent, either an organic solvent (e.g., methyl ethyl ketone (MEK), toluene, acetone, benzene, butanol, ethanol, heptane, etc.) or an aqueous solvent (e.g., water, DI water, basic solution, acidic solution).

The elastomer adhesive composition can include a peroxide-based or other accelerator, e.g., isocyanate-based, to facilitate cross-linking of the composition. Various types of organic peroxides can be used; organic peroxides undergo decomposition at a certain temperature and produce radicals that initiate a cross-linking reaction in the compound. Additionally or alternately, other cross-linkers can be used, such as isocyanates and sulfur cure agents/activators.

Examples of usable peroxide cross-linkers or curatives that are a source of free radical include those available under the trade names Dicup® 40C and Luperox® 1201 XL45.

Examples of usable adhesion promoters include ethylene glycol dimethacylate, diethylene glycol dimethacrylate, trimethlyolopropane trimethacrylae, blocked isocyantes (such as those available under the trade names Trixene® Aqua BI 200 and Trixene® BI 7982), and epoxy powders or resins.

Various additives, for example, fillers such as nanoparticles/nanomaterials or powders, wetting agents, surfactants, colorants/dyes, and film forming agents may be included in the adhesive composition.

The adhesive composition may be cured by, e.g., ambient conditions or by heating, which may be initiated by the cross-linker(s), if present. Additionally, the curing may be initiated by a photoinitiator or other source of radicals, including UV initiators, visible initiators, and IR imitators.

The polybutadiene functional groups impart compatibility to the cord, particularly to epoxy or urethane sized carbon cords, while the polybutadiene backbone is compatible (e.g., can be co-polymerized, cured, co-cured, etc.) with the elastomer or other material forming the belt body composition. The adhesive composition generates covalent bonds with any belt body composition, and with any size or pre-treatment that may be present on the cord, that has cross-linkable or unsaturated carbon-carbon bonds. Hydrogen bonding, ionic bonding, dipole-dipole interactions, and Van der Waals interactions may also be present. The result is flexible belt having better mechanical properties such as flexibility, decreased elongation, and increased modulus.

Table 1 provides example ingredient ranges for the raw materials forming the polybutadiene-based elastomer adhesive composition.

TABLE 1

| Ingredient | Wt-% |
|---|---|
| Polybutadiene (e.g., maleated polybutadiene) | 10-50 |
| Solvent | 50-90 |
| Cross-linker | 0-1 |
| Optional additives (e.g., fillers, dye, etc.) | 0-5 |

The polybutadiene functional group (i.e., the maleate group) imparts compatibility to the coated cord, while the polybutadiene backbone is compatible (e.g., can be co-polymerized, cured, co-cured, etc.) with the elastomer or other material forming the belt body composition.

The ingredients forming the adhesive composition can be blended by conventional blending methods. In some implementations, the mixing is generally carried out using an industrial mixer, such as a Banbury mixer, to mix together all ingredients; however, other mixing techniques and methods can be used. In some implementations, the individual ingredients are added into the mixer in a specific sequence to ensure sufficient incorporation and dispersion of the ingredients. In some implementations, certain raw ingredients can be mixed together prior to being added in sequence into the mix.

The adhesive composition may be, e.g., from about 10-50% solids, in some implementations about 20-30%, e.g., 25%. The adhesive composition may have, e.g., a viscosity of about 25 cps. A lower solids percentage and/or lower viscosity allows more thorough and consistent penetration of the composition into the cords, particularly in pre-twisted cord bundles.

The resulting adhesive composition can be applied to the cords, also referred to as tows or fiber tows, by conventional coating methods, including dipping, spraying, and knife coating. In some implementations, the amount of adhesive composition on the coated cord is 5-25 wt-%, in some implementations about 8-19 wt-%.

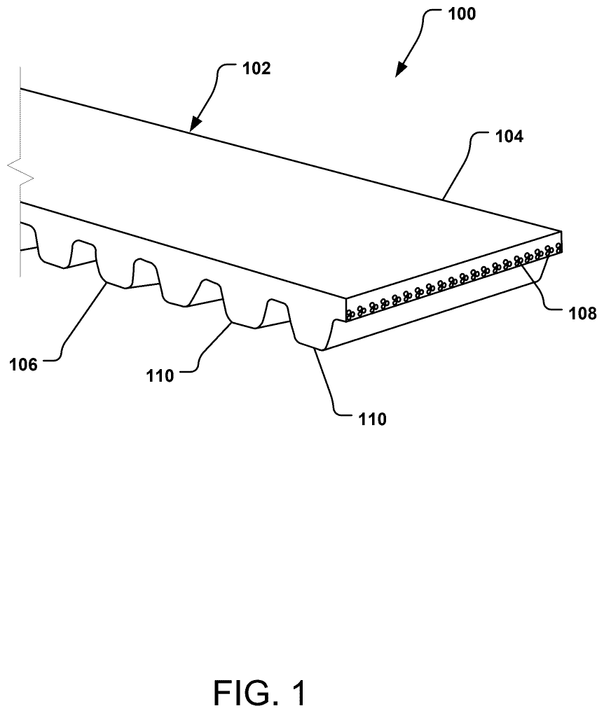

As indicated above, the polybutadiene-based elastomer adhesive composition is for treating cords used in synchronous belts for automotive and industrial applications. FIG. 1 shows a generic belt 100 incorporating the adhesive composition, the belt 100 having a body 102 formed of a flexible material having a back side 104 and a front side 106 with a plurality of load carrying cords 108 encased within the body 102, the particular cords 108 bound in triplicate bundles although in other implementations the cords 108 may be single cords or otherwise bundled. The cords 108 may be, e.g., carbon cords, polymeric cords (e.g., polyester, aramid), fiberglass cords, etc. The cords 108 are coated or otherwise treated with an elastomeric adhesive compound described herein; the adhesive is not apparent in this FIG. 1.

For this belt 100, defined in the front side 106 are a plurality of teeth 110; trapezoidal teeth are depicted in this implementation of FIG. 1 but the tooth shape is not limited thereto and can take any shape that is compatible with a sprocket, gear or other toothed wheel. Each individual tooth 110 extends perpendicular to the longitudinal length of the belt 100 so that the plurality of teeth 110 run along or around the length of the belt 100. In use, the teeth 110 on the front side 106 are in contact with a drive mechanism, e.g., a toothed gear or sprocket. Although not seen in FIG. 1, the belt 100 is an endless belt, having the form of a loop with no beginning and no end.

The elastomeric adhesive compound can be used on cords in other belts, including V-belts and non-toothed belts.

Although the most common cord treated with the elastomeric adhesive compound described herein is carbon cords, other common cords are polyester (PET) and aramid. Still other cords that can be treated with the elastomeric adhesive described herein can be cotton, sisal, jute, nylon, other plastics, glass, hybrid cords, metal, ceramic, and, of course, combinations. The cord may be made from either organic or synthetic material, or a mixture of organic and synthetic materials. The cord may be sized, for example, with a latex, polyester, cement, or other conventional size adhesive prior to coating with the elastomeric adhesive compound.

In FIG. 1, the particular cords 108 are bound in triplicate bundles of individual cords. The bundles of cords, also referred to as tows, may be any size, e.g., 3K, 6K, 24K, 48K, etc., where K represents 1,000. The elastomeric adhesive compound may be applied to the cords before or after the cords are bundled. That is, individual cords or tows may be treated with the elastomeric adhesive compound and then the bundles twisted, or the individual cords or tows may be bundled and twisted and then the elastomeric adhesive compound applied. However, by twisting before application of the elastomeric adhesive compound, better cord alignment can be achieved, resulting in a higher modulus of the final cord and better mechanical properties in the belt 100, including reduced tooth jump.

The material of the body 102 of the belt 100 is generally not limited, and any suitable material can be used; numerous examples of materials/ingredients suitable for the body 102 of the belt 100 are discussed below. Typically, the base material used for the belt body 102 and the teeth 110 is a polymer material, such as a natural or synthetic rubber material or polyurethane, although other suitable materials may also be used. Various filler materials may also be included within the material of the belt body and/or teeth to add further structural stability to the belt, while in other implementations, the belt may be free or substantially free of fillers. The belt 100 shown in FIG. 1 may also include additional features not shown in FIG. 1. For example, a cover layer (e.g., coating) may be provided on the exterior surface of the teeth 110, or a textile or polymeric backing layer may be provided on the radially outer surface of the body 102 opposite the teeth 110.

The belt body 102 is a moldable, flexible material and can be, e.g., rubber, polyurethane, polyethylene, and others. Suitable materials include, for example, polyurethane elastomers (including polyurethane/urea elastomers and so-called millable gums) (PU), polychloroprene rubber (CR), acrylonitrile butadiene rubber (NBR), hydrogenated NBR (HNBR), styrene-butadiene rubber (SBR), alkylated chlorosulfonated polyethylene (ACSM), polyepichlorohydrin, polybutadiene rubber (BR), natural rubber (NR), and ethylene alpha olefin elastomers such as ethylene propylene copolymers (EPM), ethylene propylene diene terpolymers (EPDM), ethylene octene copolymers (EOM), ethylene butene copolymers (EBM), ethylene octene terpolymers (EODM); and ethylene butene terpolymers (EBDM); ethylene vinylacetate elastomers (EVM); ethylene methylacrylate (EAM); and silicone rubber, or a combination of any two or more of the foregoing.

The raw materials forming the belt body are often in the form of a solid powder, pellet, bale or block, although in some implementations may be a liquid or semi-liquid.

The belt composition can include a peroxide or other accelerator to facilitate curing of the composition. Various types of organic peroxides can be used; organic peroxides undergo decomposition at a certain temperature and produce radicals that initiate a cross-linking reaction in the compound. One particular example of an organic peroxide for use with polyethylene is a,a-bis (t-butylperoxy) diisopropyl-benzene.

Polymer compositions cured with organic peroxides exhibit higher thermal resistance due to the formation of C—C cross links between the polymer chain. In contrast, sulfur cured polymers form C—S—C or C—(S)x-C bonds. Formation of mono sulfidic (i.e., C—S) bonds or poly sulfidic bonds (i.e., S—S) bonds leads to inferior thermal resistance of the polymer. Some sulfur-cross-links may result in poor oxidation resistance. The C—C bond energy (346 k J/mol) is higher than both C—S (272 k J/mol) and S—S (226 k J/mol) bond energy; this reflects in the higher temperature resistance of peroxide cured vulcanizate.

The belt composition can include various additives such as activators, fillers, curing agents, reinforcing materials, antidegradants (e.g., antioxidants, UV stabilizers), plasticizers, antistatic agents, colorants, processing aids, homogenizers, coagents, catalysts, and the like. Generally, the total wt-% of such additives is less than 75 wt-% of the raw ingredients of the total composition, in some implementations less than 65 wt-% or less than 50 wt-%.

Examples of activators include stearic acid and zinc oxide.

Any suitable curing agent(s) or material can be used, with the agent facilitating or assisting during curing. Example curing agent(s) suitable include sulfur and peroxides.

Silica may be added to provide greater tensile strength, higher modulus, reduced compression set, and increased abrasion resistance to the belt composition. Silica is typically a solid, e.g., powder, and may be treated or untreated. The surface area of silica is typically between 120-200 m²/g. Treated silica material has low moisture absorption and significantly low volatile formation during mixing and processing.

Carbon black and/or graphite can be used as a filler in rubber compounds. Examples of other fillers include metal oxides such as aluminum oxide, magnesium oxide, and zinc oxide, clay, montorillonite clay, pulp, and mica.

The belt composition may include reinforcement material in addition to the load carrying cords, material such as chopped fiber segments, though other reinforcement material such as elongated segments, fibers, or nanotubes, can also be used. The reinforcement material, whether chopped or elongate, may be, e.g., aramid, polyester (PET), cotton, nylon, glass, carbon fiber cords, hybrid cords, metal, ceramic, and other plastic. The reinforcement material may be made from either organic or synthetic material, or a mixture of organic and synthetic materials.

The dimensions of the reinforcement material are generally not limited. In some implementations, the chopped fibers have a high aspect ratio having a length in the range of from 0.2 mm to 3 mm. In some implementations, the reinforcement materials (e.g., chopped fibers or elongate materials) have an aspect ratio of from 10 to 250. The reinforcement material is mixed with the raw ingredients and the resulting belt has the reinforcement materials homogeneously dispersed throughout the blended composition.

Polymers, in general, are subject to degradation when exposed to different types of environmental factors, factors including oxygen, heat/temperature, UV light, weathering, catalytic degradation due to heavy metal ions, dynamic fatigue, etc. The failures observed in rubber compounds due to environmental degradation include loss of elasticity and tensile strength, formation of crazed surface, and appearance of cracks. The presence of unsaturation in a polymer can increase the tendency of failure due to heat ageing, due to the allylic C—H bond in an unsaturated chemical structure. The bond energy of allylic C—H is weakest among different type (primary, secondary, tertiary) of C—H bonds. This factor promotes the formation of free radicals and peroxy radicals in the presence of oxygen and heat and causes chain scission and cross-linking; it is noted that excessive cross-linking can create embrittlement. Once the polymer main chain is degraded and/or broken, the compound starts to lose its physical and mechanical strength and the physical properties begin to degrade. Antioxidants acts as a radical trap; they scavenge radicals to stop polymer chain scission, stabilize properties, and enhance the service life of the resulting product.

An antioxidant that can be used in belt compounds is a polymerized quinoline derivative, 1,2-dihydro-2,2,4-tri-methylquinoline. Another antioxidant is a condensate of alkylated imidazole and diarylamine or ketone, and another is a condensate of mercaptobenzimidazole and diphenyleamine/acetone; these are strong non staining antioxidants for natural and synthetic rubber and offer extremely good temperature and flex protection at elevated temperatures.

Plasticizers can be added to the belt compounds for various reasons, such as increasing softness or flexibility, lowering the glass transition temperature, reducing crystallization, increasing dispersion, or lowering the cost of the compound. Common are mineral oils and esters such as phthalates, sebacates, and adipates.

Di-alkyl ester and di octyl adipate (DOA) are highly efficient plasticizers that can be used to impart excellent low temperature flexibility and resistance to impact to the belt compound. In addition to their high efficiency and contribution to the low temperature properties, they are chemically stable and resistant to discoloration on extended exposure to temperature and ultraviolet light. The combination of low viscosity and efficiency provide excellent dry blending and processing characteristics.

Microcrystalline wax can be added as a physical antiozonant. Polymer chains containing double bonds are vulnerable to ozonolysis reaction and chain scission when in the presence of ozone. Microcrystalline wax provides a shielding layer or barrier over the compound and protects it from degradation because of chain scission.

Modified resorcinol, which is a resorcinol formaldehyde homopolymer resin modified with a selected group, can be used as a precondensed dry bonding agent; chemically, it is a resorcinol formaldehyde homopolymer resin modified with a selected group. Modified resorcinol can facilitate the bonding of the belt composition to the elastomer adhesive composition.

Metallic acrylates such as zinc dimethacrylate can be used to boost the physical and mechanical properties of the belt and acts as a coagent. In the presence of organic peroxide, metallic coagents form ionic bonds and improves tear strength, modulus, and flex resistance of the compound.

Modified polybutadiene (e.g., with maleic anhydride) can be used as a bonding promoter in peroxide cured vulcanizates. Chemically, it is a low molecular weight, low vinyl butadiene functionalized with maleic anhydride. The anhydride functionality can react with epoxy, amine, and hydroxyl groups, enabling the creation of unique adhesives, sealants, encapsulants, and coatings. It also improves compatibility of a non-polar elastomer such as EPDM and increases the adhesion of peroxide cured elastomers to polyester, aramid or metal substrates.

A substituted phenolic derivative can be used as a scorch inhibitor for peroxide cured systems. It initially forms an adduct to trap the radical from the peroxide and affects the processing and flow time to the compound.

The polymers and any other ingredients can be blended by conventional rubber blending methods. In some implementations, the mixing is generally carried out using an industrial mixer, such as a Banbury mixer, to mix together all raw ingredients; however, other mixing techniques and methods can be used. For example, roll mills and internal mixers can be used. In some implementations, the individual raw ingredients are added into the mixer in a specific sequence to ensure sufficient incorporation and dispersion of the raw ingredients. In some implementations, certain raw ingredients can be mixed together prior to being added in sequence into the mix.

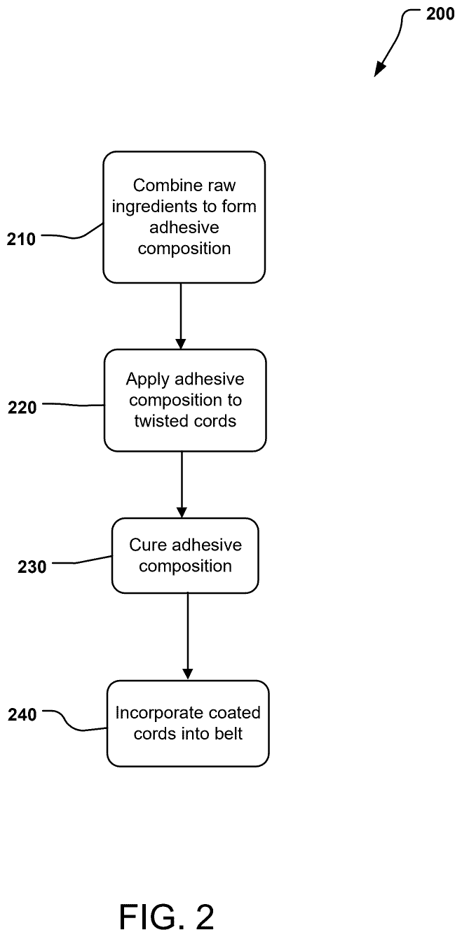

The resulting adhesive composition, from Table 1 or any described above, can be used to form a belt, such as a synchronous belt, e.g., for automotive uses, using any of the ingredients described above. FIG. 2 describes a generalized method for preparing a belt having cords coated with the adhesive composition.

FIG. 2 shows a method 200 that composition described above and with belt materials such as described above. The ingredients for the adhesive composition (e.g., as in Table 1) are combined to form an adhesive composition in step 210. In step 220, the adhesive composition is applied (coated) onto already twisted cords or tows; in an alternate step, not shown, the adhesive composition is applied to non-twisted cords or tows. After application to the cords, the adhesive composition is dried, activated, or cured in step 230, e.g., under ambient conditions, via heating, etc. The coated cord is then incorporated into a belt in step 240.

### EXAMPLES

Objects and advantages of this disclosure are further illustrated by the following non-limiting examples. The particular materials and amounts thereof recited in these examples as well as other conditions and details, should not be construed to unduly limit this disclosure. Unless otherwise noted, all parts, percentages, ratios, etc. in the Examples and the rest of this disclosure are by weight.

Examples 1, 2 and 3 were organic solvent-based composition, and Example 4 was an aqueous-based composition.

### Example 1

The materials listed in Table 2, at the amounts listed, were used to prepare an elastomer adhesive composition according to this disclosure.

TABLE 2

| Ingredient | Trade name | Supplier | wt-% |
|---|---|---|---|
| Maleated polybutadiene | Lithene Ultra | Synthomer | 12.00 |
| | N4-5000-10MA | | |
| Toluene | | Fisher | 66.67 |
| Maleated polybutadiene | Lithene Ultra | Synthomer | 12.00 |
| | AL-15MA | | |
| Methyl ethyl ketone (MEK) | | Sigma Aldrich | 9.33 |

The ingredients were mixed together. The resulting composition was brown in color, was 24% solids, and had a viscosity of 23 cps (measured with Spidle 3).

The resulting adhesive composition was coated onto a 12K carbon filament bundle and twisted to 80 turns per meters, at two different coating weights. For a Comparative example, a similar 12K carbon filament bundle was coated with an amine-cured urethane adhesive as taught by U.S. Pat. No. 11,111,342.

Results of various testing of the three coated cords was done; the results are reported in Table 3, below, where DPU represents the wt-% of the adhesive of the coated cord, and LASE represents load elongation.

TABLE 3

| | | | strain at | LASE @ | LASE @ | cord | cord peel |
|---|---|---|---|---|---|---|---|
| | DPU | Tensile | break | 0.8% | 1.0% | stiffness | adhesion |
| Adhesive | (wt-%) | (N) | (%) | (N) | (N) | (in/lb) | (lbs) |
| Ex. 1 | 15.9 | 1260 | 1.6 | 575 | 738 | 0.05 | 39.7 |
| Ex. 1 | 15.6 | 1200 | 1.5 | 625 | 802 | 0.03 | 39.7 |
| Comp. | 17.7 | 1185 | 1.3 | 725 | 910 | 1.2 | 20.5 |

Table 3 shows that the cords having the experimental adhesive composition are significantly more flexible than the cords coated with the comparative polyurea-urethane adhesive, which transcribes into easier installation of a belt having cords coated with the experimental adhesive composition compared to a belt having cords coated with the polyurea-urethan adhesive composition.

### Example 2

The materials listed in Table 4, at the amounts listed, were used to prepare an elastomer adhesive composition according to this disclosure.

TABLE 4

| Ingredient | Trade name | Supplier | wt-% |
|---|---|---|---|
| Maleated polybutadiene | Lithene Ultra | Synthomer | 9.33 |
| | N4-5000-10MA | | |
| Toluene | | Fisher | 67.83 |
| Maleated polybutadiene | Lithene Ultra | Synthomer | 9.33 |
| | AL-15MA | | |
| Methyl ethyl ketone (MEK) | | Sigma Aldrich | 8.33 |
| Epoxy | Epikote 05390 | Hexion | 5.00 |
| Peroxide cross-linker | Luperox 101XL45 | Arkema | 0.17 |

The ingredients were mixed together. The resulting composition was brown in color, was 24% solids, and had a viscosity of 23 cps (measured with Spidle 3).

### Example 3

The materials listed in Table 5, at the amounts listed, were used to prepare another elastomer adhesive composition according to this disclosure.

TABLE 5

| Ingredient | Trade name | Supplier | wt-% |
|---|---|---|---|
| Maleated polybutadiene | Lithene Ultra | Synthomer | 9.33 |
| | N4-5000-10MA | | |
| Toluene | | Fisher | 67.83 |
| Maleated polybutadiene | Lithene Ultra | Synthomer | 9.33 |
| | AL-15MA | | |
| Methyl ethyl ketone (MEK) | | Sigma Aldrich | 6.83 |
| Peroxide cross-linker | DI-Cup 40C | Arkema | 2.00 |
| Isocyanate cross-linker | Trixene BI 7982 | Lanxess | 4.67 |

The ingredients were mixed together. The resulting composition was milky brown in color, was 24.4% solids, and had a viscosity of 25 cps (measured with Spidle 3).

### Example 4

The materials listed in Table 6, at the amounts listed, were used to prepare an aqueous elastomer adhesive composition according to this disclosure.

TABLE 6

| Ingredient | Trade name | Supplier | wt-% |
|---|---|---|---|
| Isocyanate | Trixene Aqua | Lanxess | 33.33 |
| cross-linker | BI 200 | | |
| DI water | | | 40.00 |
| Latex | Pliocord VP 106 | Synthomer | 23.33 |
| | Black Shield | Emerald | 3.33 |
| | | Performance | |
| | | Materials | |

The ingredients were mixed together. The resulting composition was black in color, was 24.07% solids, had a viscosity of 25 cps (measured with Spidle 3), and pH of 8.2.

From the foregoing, it will be appreciated that specific implementations of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many implementations of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “about” or “approximately.” At the very least, and not as an attempt to limit the application of the doctrine of equivalents to the claims, each numerical parameter recited in the specification or claims which is modified by the term “about” or “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed:

1. A belt comprising a body having a plurality of load carrying cords having a polybutadiene-based adhesive composition encased therein.

2. The belt of claim 1, wherein the polybutadiene-based adhesive composition is formed from a composition comprising at least one polybutadiene and a cross-linker.

3. The belt of claim 2, wherein the at least one polybutadiene is a maleated polybutadiene.

4. The belt of claim 2, wherein the cross-linker is a peroxide.

5. The belt of claim 4, wherein the peroxide is an organic peroxide.

6. The belt of claim 1, wherein the load carrying cords are carbon cords.

7. The belt of claim 1, wherein the body is a rubber body covalently bonded to the polybutadiene-based adhesive composition.

8. The belt of claim 1, wherein the body is a polyurethane body covalently bonded to the polybutadiene-based adhesive composition.

9. A method of making a flexible belt, comprising:
forming a polybutadiene-based adhesive composition;
coating the adhesive composition onto a plurality of load carrying cords;
twisting the load carrying cords; and
incorporating the twisted and adhesive coated cords into a polymeric belt.

10. The method of claim 9, wherein twisting the load carrying cords is done before coating the adhesive composition onto a plurality of load carrying cords.

11. The method of claim 9 wherein coating the adhesive composition onto a plurality of load carrying cords is done before twisting the load carrying cords.

12. The method of claim 9, wherein the load carrying cords are carbon cords.

13. The method of claim 9, wherein coating the adhesive composition onto the plurality of load carrying cords comprises dipping the plurality of load carrying cords into the adhesive composition.

14. The method of claim 9, prior to incorporating the twisted and adhesive coated cords into the polymeric belt, curing or drying the adhesive composition.

15. The method of claim 9, wherein forming the polybutadiene-based adhesive composition comprises forming the polybutadiene-based adhesive composition from a composition comprising at least one polybutadiene and a cross-linker.

16. The method of claim 15, wherein the at least one polybutadiene is a maleated polybutadiene.
